(19) United States
(12) Patent Application Publication
(10) Pub. No.: US 2016/0085367 A1
(43) Pub. Date: Mar. 24, 2016

(54) SYSTEME D'ENTREE DE DONNEE MULTIMODE

(71) Applicant: THALES, COURBEVOIE (FR)

(72) Inventors: Michael MANCEAU, CHATEAUDUN (FR); Didier POISSON, TOULOUSE (FR); Jean-Noël PERBET, EYSINES (FR)

(21) Appl. No.: 14/862,384

(22) Filed: Sep. 23, 2015

(30) Foreign Application Priority Data
Sep. 23, 2014 (FR) 14 02128

(51) Int. Cl. G06F 3/041; G06F 3/0484; B64C 19/00; G06F 3/0488

(52) U.S. Cl. CPC G06F 3/0416; G06F 3/0412; G06F 3/04883; G06F 3/04847; B64C 19/00; G06F 2203/04808

(57) ABSTRACT

A data input system and a method implementing the system, including physical controls, an environment sensor and a touchscreen displaying virtual commands, the method defining and displaying at least one virtual control on the touchscreen and assigning a datum to be input to one of the controls. The datum to be input is assigned to both a first of the physical controls and a first of the virtual controls. The topology of the virtual controls is adapted to environmental conditions.

### BACKGROUND TO THE INVENTION

The invention relates to the field of man-machine interfaces, referred to as “MMI”, comprising a touch interface. This type of device is now widespread among the general public, particularly where the field of mobile telephones or that of touch tablets is concerned.

The field of aeronautics is also involved with this type of man-machine interface which enables the implementation of a simple, robust and ergonomic interface. Many aircraft cockpits are already equipped with touchscreens enabling the input and visualisation of information. The key advantage of touchscreens is to enable the input of information at the location of its display and therefore to minimise incorrect inputs, but this requires the operator to look at the touchscreen in order to perform the input.

Many physical controls, such as switches, push-buttons, rotary controls, etc. which similarly enable the input of information are also found on-board aircraft. These physical controls offer the advantage of enabling sensory feedback when they are operated. The user can even operate the control without looking at it. Conversely, physical controls have the disadvantage of distancing the control from the information to be modified, the information being displayed on a screen that is remote from the physical control.

Attempts have been made to combine a touchscreen with a physical control by proposing a system of programmable interfaces such as buttons or rotary controls disposed at the periphery of a touch-sensitive display area. The assignment of the physical controls varies according to the function to be performed, such as, for example, a sound volume adjustment or the choice of a radio system frequency. The same physical control can be used for different inputs. The main disadvantage of this type of combination is that it requires substantial interface training.

Other systems create predetermined areas on which a touch action can be performed and for which the priority between the touch-sensitive devices and the physical controls is managed. This allows the assignment of a touch-sensitive area to a control to be managed. The disadvantage of this solution is that it fixes the interaction area and does not guarantee consistency between the touch controls and physical controls. This type of system also requires substantial interface training.

### SUMMARY OF THE INVENTION

The invention aims to overcome all or some of the aforementioned problems. The object of the invention is to improve the use of man-machine interfaces by proposing a consistent and intuitive system to the user, combining touch surfaces implementing a virtual representation of controls on a screen and physical controls. The interface guarantees optimum utilisation, taking account of the environment in which it is used, the task to be completed and the performances and preferences of the user.

For this purpose, the subject-matter of the invention is a data input method implementing a system including physical controls, an environment sensor and a touchscreen displaying virtual commands, the method consisting in defining and displaying at least one virtual control on the touchscreen and assigning a datum to be input to one of the controls. The datum to be input is assigned to both a first of the physical controls and a first of the virtual controls. The topology of the virtual controls is adapted to environmental conditions.

A second of the virtual controls is advantageously displayed at a predefined position on the touchscreen, said position being located more or less along an edge of the touchscreen, and the assignment of the datum is defined by means of the second of the virtual controls.

The edge of the touchscreen advantageously has a relief allowing a user to stop his finger there in order to locate the position of a virtual control on the touchscreen without having to look at the screen.

The touchscreen may have a rectangular outline and the second of the virtual commands is advantageously displayed more or less in one of the corners of the rectangular outline. The positioning of a virtual command along an edge or a corner associated with the presence of the relief simplifies the operation of this virtual control for the operator.

The datum to be input may be a continuous or pseudo-continuous datum and the virtual control forms a cursor advantageously extending along an outline of the touchscreen. The user can then move his finger along the outline in order to operate the control. In the case of a rectangular outline, the cursor then extends along an edge of the outline of the touchscreen.

Furthermore, if the datum to be input is a continuous or pseudo-continues datum, the physical control associated with his datum may include a rotary button. The user can then choose between a virtual cursor and a rotary button to input the datum.

The subject-matter of the invention is also a system including a computer, physical controls, an environment sensor and a touchscreen displaying virtual commands, the physical commands and the touchscreen being connected to the computer. The computer is configured to implement an inference engine defining contextual rules for assignment of the controls to data to be input, at least one of the data to be input being assigned to both a first of the physical controls and a first of the virtual controls. The computer is configured to adapt the topology of the virtual controls to environmental conditions measured by the environment sensor.

The computer is advantageously configured to implement a topological memory block registering the different controls of the system and their position.

The topological memory block advantageously stores positions of virtual controls located more or less along an edge of the touchscreen.

The computer is advantageously configured to implement an action memory block defining the actions to be performed according to the value of each input datum. The action memory block then operates on the basis of patterns defined as structures or organisations of the actions that can be transformed or generalised during the repetition of actions in similar or related circumstances.

A physical control is understood to mean any data input means having a mobile element which an operator can move in relation to a fixed element in order to input a datum. By way of example, a physical control may be formed by a binary control such as a push-button or a lever switch, wherein said button or switch may have a single or dual action. The binary controls may be grouped together in a physical keypad. The physical control may also be formed by a continuous or pseudo-continuous control such as a sliding or rotary potentiometer, a rotary switch controlling electrical contacts or an optical coder.

A virtual control is understood to mean a control implemented by way of a touchscreen. These controls may also be binary or continuous (or pseudo-continuous). The virtual controls are formed from areas of the touchscreen which the user is required to touch in order to input a datum. The virtual controls are defined by software managing the touchscreen. The software defines areas of the screen forming controls, the size of the areas being compatible with a standard size of a finger of a user. The software also defines the function performed by each control. The touchscreen displays a graphical representation of the virtual control. The representation may be functional, for example by representing the image of a button on which the user is prompted to place his finger.

The system is referred to as multimode since it allows the user to choose between a physical control and a virtual control in order to input the same datum.

The implementation of a system or a method according to the invention limits the need for the user to look at the different controls in order to focus on the performance of his operation. This allows the user to observe the outside world during the operation of the controls.

The invention is particularly suitable for systems installed in instrument panels on-board vehicles, such as, for example, aircraft, motor vehicles or trains. The user is then in control of the vehicle, for which it is desirable that he can continue his observation of the external environment even during a data input.

The implementation of a method according to the invention offers flexibility of use by allowing the user to choose between different controls enabling him to input the same datum. By being adaptable to the preferences of the user, the system implementing the inventive method requires less training, thereby limiting the cognitive load on the user.

### BRIEF DESCRIPTION OF THE FIGURES

The invention will be more easily understood and other advantages will become clear from a reading of the detailed description of an embodiment, presented by way of example, said description being illustrated by the attached drawing, in which:

FIGS. 1a, 1b and 1c show schematically an interface including virtual controls and physical controls;

FIG. 2 shows schematically a system that is suitable for implementing the invention.

In the interests of clarity, the same elements will be designated by the same reference numbers in the different figures.

### DETAILED DESCRIPTION OF THE INVENTION

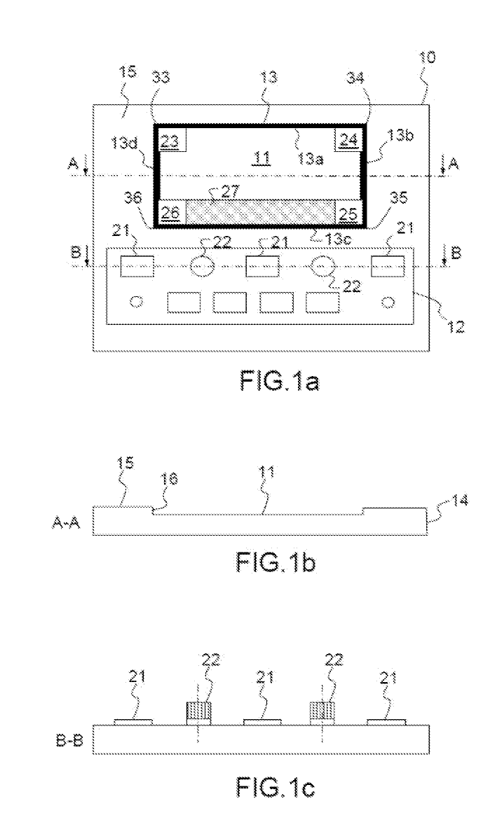

FIG. 1a shows a front view of an interface 10, for example intended to be installed in an instrument panel of the cockpit of an aircraft. The interface 10 includes a touchscreen 11 and a group 12 of physical controls. In the example shown, the touchscreen 11 has a rectangular outline 13. Other outline shapes are obviously possible, such as, for example, circular or polygonal outlines. The outline 13 includes four edges 13a, 13b, 13c and 13d.

FIG. 1b shows the interface 10 in a cross-section view of the area of the touchscreen 11. The interface 10 includes a body 14 intended to be attached to the instrument panel. The touchscreen 11 is advantageously indented in relation to a visible side 15 of the body 14. Alternatively, the touchscreen 11 may be protruding in relation to the side 15. The outline 13 has a relief 16. The relief 16 allows a user to locate the outline 13 of the touchscreen 11 by touch.

FIG. 1c shows the interface 10 in a cross-section view of the group 12. The physical controls include, for example, three push-buttons 21 and two rotary buttons 22. The push-buttons 21 enable the input of binary data, and the rotary buttons 22 enable the input of continuous or pseudo-continuous data. A pseudo-continuous datum is understood to mean a datum that can assume a plurality of discrete values spread over a range. The rotary button may be notched for the input of pseudo-continuous data.

The touchscreen 11 displays a plurality of virtual controls 23 to 27. The controls 23 to 26 enable the input of binary data and the control 27 enables the input of continuous or pseudo-continuous data. The control 23 is disposed in a corner 33 of the screen 11, said corner forming the intersection of the edges 13a and 13d. Similarly, the control 24 is disposed in a corner 34 forming the intersection of the edges 13a and 13b, the control 25 is disposed in a corner 35 forming the intersection of the edges 13b and 13c, and the control 26 is disposed in a corner 36 forming the intersection of the edges 13c and 13d. The control 27 forms a cursor along which the user can move his finger in order to input a datum. The control 27 is disposed along the edge 13c.

The shape of the different controls 23 to 27 is visualised on the screen 11. The datum assigned to the control may also be displayed on the touchscreen 11, either directly on the control, or in close proximity. The user can look at the touchscreen 11 in order to guide his finger to allow him to actuate one of the controls. The controls 23 to 27 being disposed in the corners or along an edge of the screen 11, the user can thus reach one of the controls by identifying his position simply by touch by means of the relief 16. More generally, the virtual controls 23 to 27 are disposed at key points on the screen 11.

In the example shown, the virtual controls 23 to 27 are disposed precisely along the edges of the screen 11. Alternatively, a space can be provided between the virtual controls 23 to 27 and the edges of the screen 11.

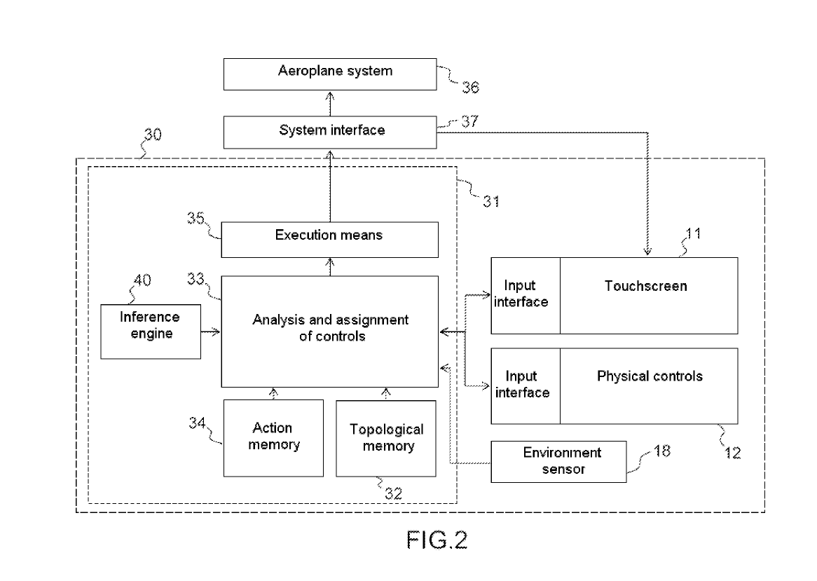

FIG. 2 shows schematically a system 30 that is suitable for implementing the invention. The system 30 includes a computer 31, an environment sensor, the touchscreen 11 and the group 12 of physical controls. The computer 31 includes one or more processors and one or more memories. Software stored in the memory allows the processor to execute a process that can be broken down into a plurality of functional blocks. The environment sensor is, for example, an accelerometer or a rate gyroscope or an inertial unit. The environment sensor is notably sensitive to vibrations that may occur in a carrier equipped with the system 30. The environment sensor may also be a temperature sensor.

A block 32, referred to as a “topological memory”, registers the different controls of the system 30 and their position. The position of the physical controls is fixed by nature. Conversely, the position of the virtual controls may vary on the surface of the touchscreen 11. It is nevertheless advantageous to fix the position of some virtual commands in order to improve the ergonomics of the system and limit the need for the user to look at the different controls in order to locate them. The virtual controls located at key points on the touchscreen 11 can be used, for example, to perform different functions, notably the controls 23 to 27.

The functional block 32 includes, in particular, the key points on the touchscreen. It takes account, in particular, of the geometry of the group of buttons in relation to the touchscreen, its accessibility and the criticality of the controls. It may, in particular, take account of a usage by the pilot or co-pilot and by them both together.

The block 32 adapts the topology of the virtual controls to environmental conditions. For example, the block 32 can guarantee the safety of the actuations of the controls according to the flight conditions and, in particular, during significant vibrations (for example on-board a helicopter) or during turbulence. For example, the block 32 can modify the area occupied on the screen by each of the virtual controls according to the intensity of the vibrations to which the system is subjected. The system may include one or more accelerometers connected to the computer 31 in order to measure the intensity of the vibrations.

A block 33 enables the analysis and the assignment of the physical and virtual controls. On the one hand, the block 33 assigns data to be input to virtual and physical controls. On the other hand, the block 33 receives the information input by the user by means of the controls that have been assigned.

A block 34, referred to as an “action memory”, defines the actions to be performed according to the value of each input datum. Following analysis of a value of a received datum, the block 33 interrogates the block 34 in order to define the action to be performed. It defines, in particular, information-decision-action sequences, taking account of the conditions and the phase of the flight or operation. The block 34 advantageously operates on the basis of patterns which are defined as structures or organisations of the actions such that they are transformed or generalised during the repetition of these actions in similar or related circumstances. It is notably possible to take account of the training and/or the expertise of the user, for example on the basis of a measurement of his reaction time in operating certain controls, on the basis of his repeated use of one control rather than another when a choice is offered to him, etc.

A block 35, referred to as an “execution means”, performs the action defined in the block 33 and transmits it outside the system 30 and, more precisely, to an aeroplane system 36, possibly via a system interface 37.

The system 30 also includes a block 40, referred to as an “inference engine”, which defines contextual rules for assignment of the controls. The inference engine 40 is connected to the block 33. The inference engine 40 notably defines the future assignment rules of the controls according to past actions.

The inference engine 40 enables the performance of an automatic search for rules to be applied, taking account of the control to be performed by the operator, without them being entirely fixed in the system. It is made up of the set of deductive logical “IF-THEN” rules. The conditions enabling modification of the rules may be the flight phase, the expertise of the user, the use by the pilot or co-pilot or both, etc. This set of rules must guarantee the safety of the data input actions, in particular according to various levels of expertise required for the user and the implicit phase of the flight or operation in which the user is involved. By way of example, a landing phase which requires a wider view of the outside world must enable the use of blind control, i.e. without looking at the control: touchscreen or physical control.

According to the invention, a datum to be input is assigned to a plurality of controls. For inputting the datum concerned, the user thus retains the choice of using one control or another according to his preferences. More precisely, the user retains the choice of using a physical control or a virtual control. For example, in order to input a continuous datum, the inference engine can define the assignment of this datum to both the virtual control 27 and one of the rotary buttons 22. For example, in order to adjust a sound volume, the user has the choice of using either the cursor formed by the virtual control 27 or the selected rotary button 22.

One of the virtual controls disposed at a key point on the touchscreen 11 is advantageously used for the definition of the assignment of the datum to the different controls. For example, in order to control radio reception, the control 23 enables a changeover to a frequency selection mode. The choice of the frequency is then made either with the virtual control 27 or with a rotary button 22. If the choice of the frequencies cannot be made using a cursor, due to the excessively large number of possible frequencies, a numeric keypad may appear on the touchscreen 11. However, it is possible to retain one of the rotary buttons, for example if it is a notched button, for the frequency input. The user can then choose between a virtual numeric keypad and a notched button.

Once the frequency has been input, a different key point can be used to change over to a radio sound volume selection mode. For example, the changeover to this mode is implemented by means of the control 24. In this mode, the volume adjustment can also be carried out by means of the same controls as those used for the frequency selection: the virtual control 27 and the rotary button 22 previously used.

1. A data input method implementing a system including physical controls, an environment sensor and a touchscreen displaying virtual controls, the method defining and displaying at least one virtual control on the touchscreen and assigning a datum to be entered to one of the controls, the datum to be entered being assigned to both a first of the physical controls and a first of the virtual controls by adapting the topology of the virtual controls to environmental conditions.

2. The method according to claim 1, wherein a second of the virtual controls is displayed at a predefined position on the touchscreen, said position being located more or less along an edge of the touchscreen, and wherein the assignment of the datum is defined by means of the second of the virtual controls.

3. The method according to claim 2, wherein the edge of the touchscreen has a relief.

4. The method according to claim 2, wherein the touchscreen has a rectangular outline and wherein the second of the virtual controls is displayed more or less in one of the corners of the rectangular outline.

5. The method according to claim 1, wherein the datum to be input is a continuous or pseudo-continuous datum and wherein the virtual control forms a cursor extending along an outline of the touchscreen.

6. The method according to claim 4, wherein the cursor extends along a side of the outline of the touchscreen.

7. The method according to claim 1, wherein the datum to be input is a continuous or pseudo-continuous datum and wherein the physical control includes a rotary button.

8. A system including a computer, physical controls, an environment sensor and a touchscreen displaying virtual controls, the physical controls and the touchscreen being connected to the computer, wherein the computer is configured to implement an inference engine defining contextual rules for assignment of the controls to data to be input, at least one of the data to be input being assigned to both a first of the physical controls and a first of the virtual controls, and wherein the computer is configured to adapt the topology of the virtual controls to environmental conditions measured by the environment sensor.

9. The system according to claim 8, wherein the computer is configured to implement a topological memory block registering the different controls of the system and their position.

10. The system according to claim 9, wherein the topological memory block stores positions of virtual controls located more or less along an edge of the touchscreen.

11. The system according to claim 8, wherein the computer is configured to implement an action memory block defining the actions to be performed according to the value of each input datum, and wherein the action memory block operates on the basis of patterns defined as structures or organisations of the actions that can be transformed or generalised during the repetition of actions in similar or related circumstances.
